(19) United States
(12) Patent Application Publication
(10) Pub. No.: US 2025/0163952 A1
(43) Pub. Date: May 22, 2025

(54) Sensorized Fastener, Pin, Production Process and Processing Line

(71) Applicant: SENS-IN S.R.L., San Lazzaro Di Savena (IT)

(72) Inventor: Michele Poggipolini, San Lazzaro Di Saveno (IT)

(73) Assignee: SENS-IN S.R.L., San Lazzaro Di Savena, BO (IT)

(21) Appl. No.: 18/840,010

(22) PCT Filed: Feb. 20, 2023
(86) PCT No.: PCT/IB2023/051541

§ 371 Date: Aug. 20, 2024

(30) Foreign Application Priority Data
Feb. 22, 2022 (IT) 102022000003317

(51) Int. Cl. F16B 31/02; F16B 35/00

(52) U.S. Cl. CPC F16B 31/025; F16B 35/00

(57) ABSTRACT

A sensorized fastener, in particular a screw, having a shank with a cavity laterally delimited by a lateral surface and extending between an opening, through which the cavity faces the outside of the fastening body, and an end portion. The sensorized fastener has a pin with a support formed by a head, a foot and an intermediate portion, which is interposed between the head and the foot, and a sensing element which is applied to the intermediate portion. The pin is inserted, at least partially, through the opening within the cavity, so that the foot of the pin is fixed to the end portion of the cavity.

### CROSS-REFERENCE TO RELATED APPLICATIONS

This patent application claims priority from Italian Patent Application No. 102022000003317 filed on Feb. 22, 2022, the entire disclosure of which is incorporated herein by reference.

### TECHNICAL SECTOR

The present invention relates to: a sensorized fastener, in particular a sensorized screw, comprising a pin; a pin; a production process; and a line for the automated production of a sensorized fastener according to the present invention.

### STATE OF THE PRIOR ART

It is known to use fasteners, in particular screws, to connect two or more components of a mechanical apparatus together. Fasteners, in particular screws, are used in a large number of mechanical apparatuses. A fastener generally comprises a shank, which is the connecting/holding element. Depending on the type of fastener, the shank may have a head or may cooperate with other components such as: nuts, washers or the like.

An example of a fastener is the stud bolt or tie rod, which in addition to the shank comprises a head, which protrudes both axially and radially outside the shank. Other types of fasteners such as special screws, pins, rivets or the like are also known.

Preferably, the present invention relates to fasteners, in particular screws, made of a material that is lighter than steel and highly performing (typically for automotive or aerospace applications). For example, the present invention relates to fasteners made of a material with a high mechanical and thermal resistance, e.g. made of titanium alloy.

It is also known to provide for sensors installed on the fasteners, however, during use, the sensors are also subject to the high stresses affecting the fastener, with the risk that the sensor detaches from the fastener during use, or that errors, interfering with the proper detection of the signals, occur.

Considering the above as well as the need for a wired connection of the sensors to a power source, known-type sensorized fasteners are generally used for bench tests or during testing, namely in conditions wherein an operator has the possibility of directly accessing to the fastener for any corrections or positioning adjustments.

Known-type sensorized fasteners are manually assembled in the laboratory, are made in limited numbers and are particularly expensive to produce.

### DISCLOSURE OF THE INVENTION

Fasteners, in particular screws, are subjected to high mechanical and thermal stresses during use, hence they must have a high mechanical (and often also thermal) strength to ensure adequate fatigue resistance and proper functioning over time of the mechanical apparatus wherein they are applied.

Fasteners, in particular screws, are often installed during use in positions subjected to high vibrations. For example, at a cylinder head of an endothermic engine, or on vehicles for aeronautical or aerospace applications. Or fasteners are applied in particularly critical structures subjected to high loads, such as trellis, cranes, bridges or similar structures. In other cases, fasteners are installed in precision automatic machines and, thus, it is required to ensure, in addition to fatigue life strength, also maximum fastening accuracy over time.

The known-type fasteners of a complex system, such as a mechanical apparatus (such as a machine), are not capable of dynamically detecting pre-established working conditions, i.e. to generate signals according to instantaneous conditions of use.

The sensorized fasteners of the known-type are manually assembled and are expensive to manufacture, thus they are only used for bench testing, in other words, for sample testing.

Sensorized fasteners of the known type do not have adequate chemical, physical and mechanical characteristics to ensure the proper detection of signals by the sensors even during prolonged use (substantially corresponding to the entire life of the fastener itself) and during normal use of the mechanical apparatus (i.e. not under test conditions but in the presence of multiple and unpredictable conditions of use, during the entire life of the mechanical apparatus).

The aim of the present invention is to provide a sensorized fastener which can be manufactured automatically and has a fatigue life comparable to that of a conventional fastener.

The aim of the present invention is to provide a pin configured to be automatically manipulated, e.g. along an automated processing line, and capable of being stably fixed, i.e. constrained, within a respective cavity of a fastener.

The aim of the present invention is to provide a pin that is capable of maintaining a stable connection to the fastener shank under any conditions of use, for an extremely long period of time (substantially corresponding to the entire life of a conventional fastener) and under any conditions of use, even under conditions of extreme dynamic/thermal stress. Advantageously, the pin according to the present invention is realised so as to support and/or integrate sensors (or equivalent components) therein.

The aim of the present invention is to provide a mechanical pin capable of arranging in a specific way a sensor within a cavity of a fastener.

The aim of the present invention is to provide a sensorized fastener, in particular a screw, which comprises a sensorized pin, that is cheap to manufacture so that it can be used on a large scale and not only under test conditions. Thus, advantageously, applying a sensorized fastener according to the present invention in a mechanical apparatus, on top of ensuring its own fastening function between mechanical apparatus components, also enables to detect certain signals.

The aim of the present invention is to provide a production process and a processing line for automating and industrialising the assembly of a sensorized fastener according to the present invention.

According to the present invention, a sensorized fastener is provided according to what mentioned in the appended Claims.

According to the present invention, a pin is provided according to what mentioned in the appended Claims.

According to the present invention, a production process is provided according to what mentioned in the appended Claims.

According to the present invention a processing line is provided according to the present invention.

### BRIEF DESCRIPTION OF THE DRAWINGS

The invention will be now described with reference to the enclosed drawings, which show an exemplary non-limiting embodiment thereof, wherein:

FIG. 1 is an exploded view of a sensorized fastener according to the present invention;

FIG. 2 is the longitudinal section of the sensorized fastener of FIG. 1;

FIG. 2A is the enlargement A of FIG. 2;

FIG. 3 shows, to an enlarged scale, the section according to lines III-III of FIG. 2A of a detail of the fastener;

FIG. 4 is an exploded view of a variant of a sensorized fastener according to the present invention;

FIG. 5 is the longitudinal section of the sensorized fastener of FIG. 4;

FIG. 6 is an exploded view of a variant of a sensorized fastener according to the present invention;

FIG. 7 is the longitudinal section of the sensorized fastener of FIG. 6;

FIG. 8 is an exploded view of a variant of a sensorized fastener according to the present invention;

FIG. 9 is the longitudinal section of the sensorized fastener of FIG. 8;

FIG. 10′ is a longitudinal section of a further variant of a sensorized fastener according to the present invention;

FIG. 10″ is a perspective view of a detail of FIG. 10′;

FIG. 10B is the view according to the arrow B of FIG. 10″;

FIG. 11 is an exploded view of a variant of a sensorized fastener according to the present invention; and,

FIG. 12 is a diagram of a processing line for producing a sensorized fastener according to the present invention.

### PREFERRED EMBODIMENT OF THE INVENTION

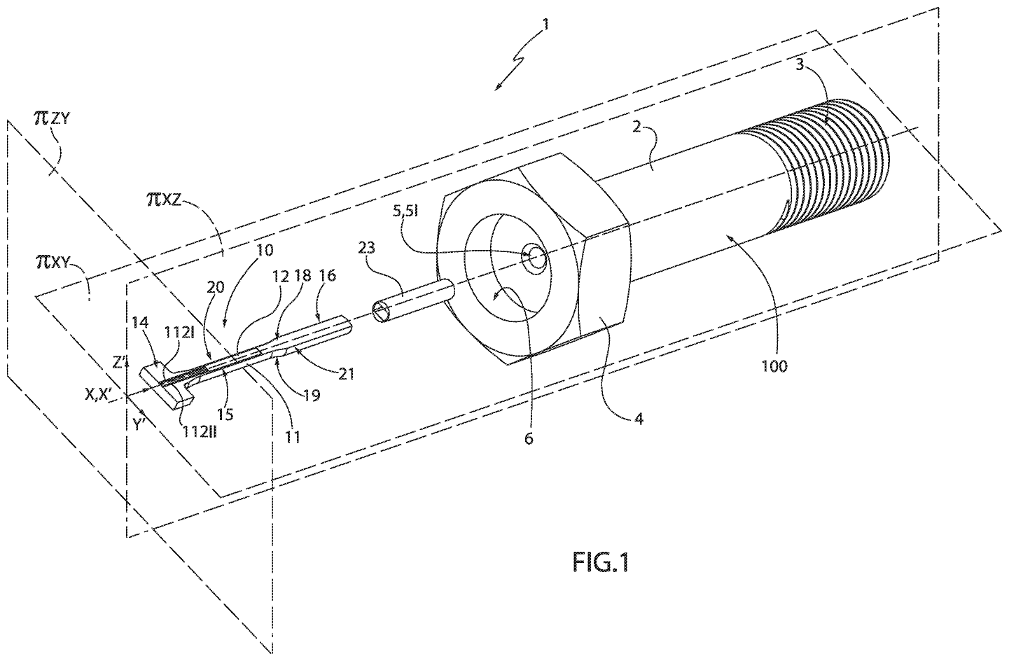

In FIG. 1 a sensorized fastener according to the present invention is globally denoted by number 1.

A fastener refers to an element configured to: connect two or more mechanical components of a mechanical apparatus to each other; be subjected to high thermal, static (tensile or compressive loads) and/or dynamic stresses, i.e. vibrations, during use. Sensorized fastener refers to an element which, in addition to the aforementioned connection abilities, is configured to detect certain signals.

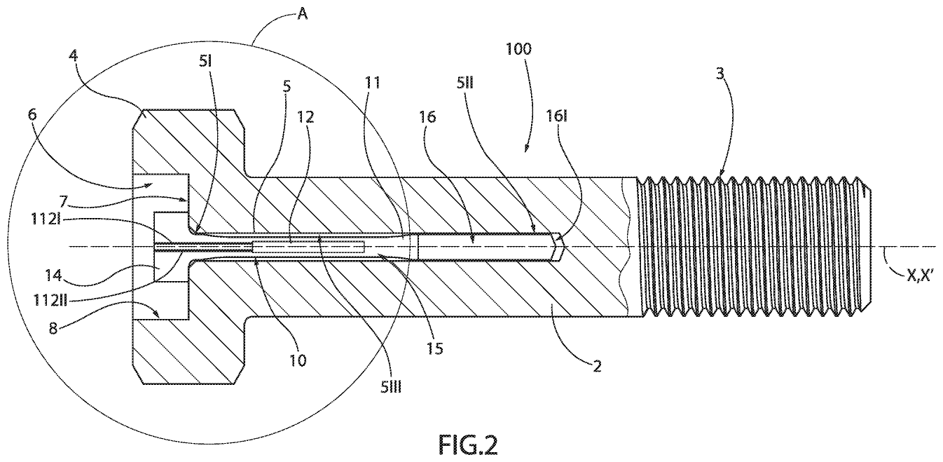

As will be better shown hereinafter, the sensorized fastener 1 comprises a fastening body 100 (in particular, a screw) which has a cavity 5, and a sensorized pin 10 fixed within the cavity 5 itself (FIG. 2).

Advantageously, the sensorized fastener 1 is configured to withstand high temperatures, in particular temperatures above 1300° C.

Advantageously, the fastening body 100 of the sensorized fastener 1 is made of a material with a high mechanical strength. By way of exemplary but non-limiting purposes, the fastening body 100 of the sensorized fastener 1 is made of a metal material, such as: steel alloys, titanium alloys or equivalent materials. By way of exemplary but non-limiting purposes, the sensorized fastener 1 is made of any material selected from a group of materials with a high mechanical strength and comprising: titanium; nickel-chromium alloys generally known as INCONEL®; X1CrNiMoAlTi12-11-2 stainless steel generally known as MLX17®; X1NiCrMoAlTi12-10-2 stainless steel generally known as MLX19®; and PH (Precipitation Hardening) class stainless steels between 13-8 or 15-5 or 17-4; steel with composition Si, 19.00-21.00 Cr, 33.00-37.00 Ni, 9.00-11.00 Mo, 1.00 max. Ti, 0.01 B, 1.00 max Fe, Bal Co generally known as MP35NR; steels including nickel and cobalt generally known as MARAGING® and/or VASCOMAX®, e.g. MARAGING300 or AERMET®100; AISI4340 and AISI304 steels.

According to the schematic example shown in FIG. 1, the fastening body 100 of the sensorized fastener 1 is a screw. Without losing generality and according to non-shown variants, the fastening body 100 may be of a different type. For example, the fastening body 100 may be: a stud bolt; a tie rod; or it may be coupled with a nut to form a bolt. For example, according to the present invention the following may be considered as fastening bodies 100: rivets, screws, tie rods, or equivalent solutions.

Hereinafter, for ease of simplicity, reference will be made to the example of fastening body 100 shown in the Figures. The dimensions and shape of the fastening body 100 are for illustrative and non-limiting purposes only.

The fastening body 100 comprises a shank 2 (substantially cylindrical in shape having a longitudinal axis X), a thread 3 and a head 4.

According to the example shown, the thread 3 is external, i.e. it is made on a respective external portion of the shank 2. The thread 3 shown is for illustrative and non-limiting purposes only. Without losing generality, the fastening body 100 may have a different number of external threads (e.g. two in the case of a stud bolt) just as the arrangement and embodiment of the threads may be different (external; in different positions; internal and similar).

As shown in FIG. 2, the fastening body 100 has a cavity 5, which extends along the longitudinal axis X. Advantageously, the cavity 5 is a blind hole. The cavity 5 extends between an opening 51 and an end portion 5II, hereinafter referred to as end portion 5II.

The opening 5I connects the cavity 5 with the outside at one end of the fastening body 100. The cavity 5 is coaxial to the longitudinal axis X. The cavity 5, preferably though non-exclusively, has a circular section. According to a variant not shown, the cavity 5 has a differently shaped section, for example: a curved closed line; a mixed closed line; or a polygonal closed line.

The cavity 5 is laterally delimited by a lateral surface 5III and has a cylindrical shape with a constant section along the longitudinal axis X. According to variants not shown, the cavity 5 may have sections with varying dimensions and/or shapes of the sections along the longitudinal axis X.

The fastening body 100 also has a housing 6 which is made inside the head 4. The housing 6 is laterally delimited by a base surface 7 and a lateral surface 8. The opening 51 of the cavity 5 is made through the base surface 7 of the housing 6.

The sensorized fastener 1 further comprises a pin 10 which is inserted inside the cavity 5.

The pin 10 comprises, in turn, a support 11 having a longitudinal axis X′ and a sensing element 12.

The sensing element 12 may be anchored directly to the support 11 (as will be explained better hereinafter) or it can be fixed to the support 11 by means of an intermediate element, for example, the sensing element 12 may be glued or welded to the support 11.

According to the example shown in FIGS. 1 and 2, the support 11 is symmetrical to a longitudinal plane of symmetry πxz. Hereinafter, the following planes perpendicular to each other and to the longitudinal plane of symmetry πxz will be taken as reference: the lateral plane πxy and the transverse plane πzy (shown in FIG. 1).

The longitudinal axis X′ is the axis of intersection between the longitudinal plane of symmetry πxz and the lateral plane πxy. The lateral axis Y′ is the axis of intersection between the lateral plane πxy and the transverse plane πzy. The transverse axis Z′ is the axis of intersection between the longitudinal plane πxz and the transverse plane πzy. The term “length” refers to the extension along the axis X′. The term “width” refers to the extension along the axis Y′. The term “thickness” refers to the extension along the axis Z′. The same reference system and terminology are also used mutatis mutandis for the fastening body 100 and sensorized fastener 1.

The pin 10 may be made of any material. In particular, the support 11 may be made of a material with chemical-structural and mechanical properties determined according to the type of application of the sensing element 12 and the substrate 11 itself. Advantageously, the support 11 of the pin is made of the same material as the fastening body 100; thus, the chemical-structural and mechanical properties of the pin 10 are the same (or substantially the same) as those of the fastening body 100. This has the technical effect of achieving, during use, uniformity in the physical and/or electro-chemical phenomena occurring in the fastening body 100 and pin 10. Advantageously, the fact that the fastening body 100 and the support 11 of the pin 10 are made of a same material, or of materials with similar chemical-structural and mechanical properties, allows to obtain greater precision in signal detection by the sensing element 12.

For example, according to a further alternative, the support 11 may advantageously be made of a more yielding material, i.e. having a lower Young modulus, than the material of the fastening body 100 so as to obtain, under greater the application of the same tensile force, a stretching in the support 11 than in the fastening body 100 (substantially so that the effects of the physical phenomena applied to the fastening body 100 are greater in the support 11).

For exemplary but non-limiting purposes, examples of possible physical phenomena are: thermal expansion; elastic deformation; plastic deformation; viscoelastic deformation; vibration; heat flow. This advantageously results in greater accuracy of the signals detected by the sensing element 12, as the effects of any external agents on the fastening body 100 are offset by the same effects occurring in the pin 10.

Advantageously, the support 11 of the pin 10 is made of an elastic material, i.e. a material that allows to elastically deform. This makes it possible to use the support 11 even in highly stressed contexts. This would not be possible with a support made of a fragile material, such as silicon, i.e. the materials traditionally used as sensor supports.

According to the example shown in FIG. 1, the support 11 of the pin 10 comprises, in turn, a head portion, hereinafter referred to as head 14, an end portion, hereinafter referred to as foot 16, and an intermediate portion 15. The intermediate portion 15 is interposed along the longitudinal axis X′ between the head 4 and the foot 16. According to the example shown, advantageously, the head 14, the intermediate portion 15 and the foot 16 are portions made in a single piece. According to a variant not shown, the head 14, the intermediate portion 15 and the foot 16 are distinct bodies connected to each other.

The head 14, the intermediate portion 15 and the foot 16 have shapes and/or sizes differing from each other, as will be further better explained hereinafter. Advantageously, the cavity 5 has such a shape and dimensions as to house the pin 10. The foot 16 may have shapes and/or dimensions different from those shown. In particular, the foot 16 is configured to engage the end portion 5II of the cavity 5.

Advantageously, the foot 16 of the pin 10 and the end portion 5II are configured to achieve form fitting and/or interference coupling.

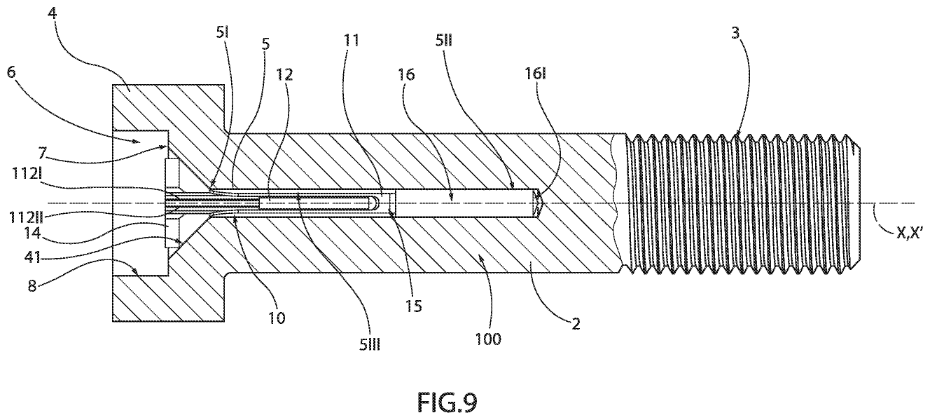

Advantageously, fixed in a non-releasable way to the end portion 5II. According to the example shown in FIGS. 1 to 4, the foot 16 is glued to the end portion 5II. In this case, advantageously, the foot 16 has a pointed end 161. In the example shown in FIGS. 2 and 9, the end 16I is cone-shaped. The dimensions of the end 16I are such as to obtain a volume defined between the support 11 and the end portion 5II of the cavity 5, so as to obtain a fastening defined between the support 11 of the pin 10 and the shank 2. The shape and dimensions of the end 16I depend on the shapes and dimensions of the respective end portion 5II of the cavity 5 and on the type of fastening to be realized (e.g. depending on the type of material used to perform the gluing operation and/or the type of welding chosen, etc.).

Advantageously, the projection on the transverse plane πzy of the total area of the intermediate portion 15 is lower than the projection on the same transverse plane πzy of both the area of the head 14 and the area of the foot 16. In other words, the width of the intermediate portion 15 is lower than both the width of the head 14 and the width of the foot 16. According to the examples shown in the Figures, and as will be better shown hereinafter, the support 11 has a shape that is commonly known as “dog-bone”.

The sensing element 12 is disposed in correspondence of the intermediate portion 15. In other words, the sensing element 12 is disposed in correspondence of the portion with a small section of the support 11 of the pin 10.

Advantageously, the sensing element 12 is anchored, i.e. integrated, to the support 11. In other words, the sensing element 12 was made directly on a respective portion of the support 11 and may not be divided from the support 11 itself. For example, the sensing element 12 may have been made by deposition techniques or electro-chemical material deposition processes.

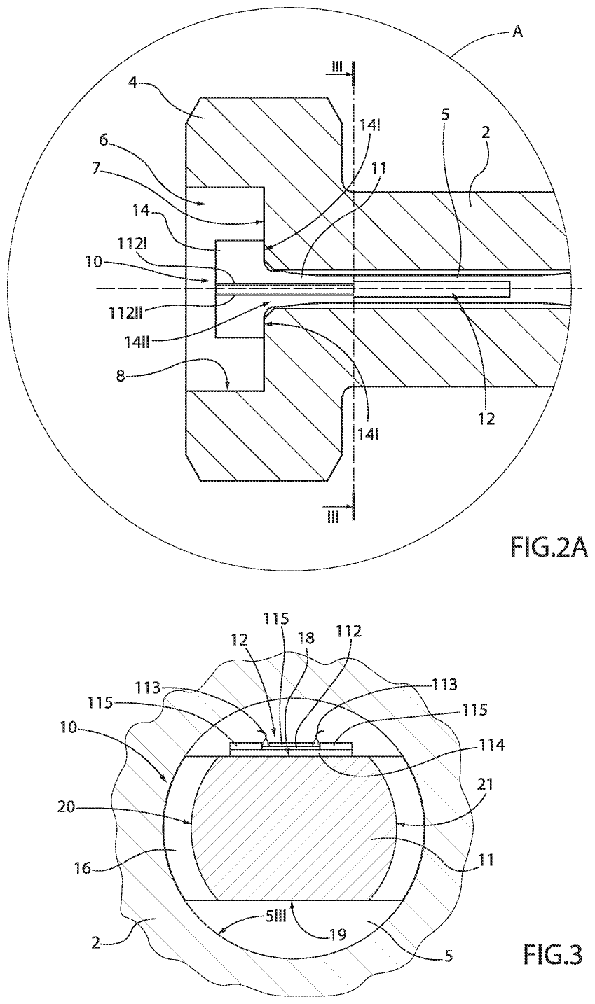

The sensing element 12 is thereby anchored (by virtue of physical-chemical bonds) to the respective portion of the support 11. According to the enlargement of the pin 10 shown in FIG. 3, the sensing element 12 comprises: at least one track 112 of conductive material; connectors 113 (e.g., wires or cables) fixed at respective portions of the track 112. The track 112 may be made in a variety of ways, differing in: shape, extent and number of tracks. The number and arrangement of the connectors 113 may differ depending on the type of track 112.

According to the example shown in FIGS. 1 and 2, two connecting tracks 1121 and 112II extend along the support 11 to the head 14 to allow connection of the sensing element 12 with components arranged outside the cavity 5. In particular, the connecting 112I tracks and 112II protrude outside the support 11 of the pin 10 through the head 14. The connecting tracks 1121 and 112II may thereby be brought into contact with connectors (not shown in FIGS. 1 and 2) of, for example, electronic devices which may be inserted, at least partially, into the housing 6.

FIG. 3 schematically shows a cross-section of the sensing element 12. As shown in FIG. 3, the pin 10 further comprises a layer of insulating material 114; and a cover 115. The layer of insulating material 114 is interposed between the track 112 and the support 11. The layer of insulating material 114 covers, at least partially, the support example, the insulating material 114 covers the head 14 and the intermediate portion 15. Advantageously, the layer of insulating material 114 is made of or comprises an electrically insulating material.

The cover 115 covers the track 112. In other words, the track 112 is interposed between the support 11 and the cover 115. More in detail, the track 112 is interposed between the coating 114 and the cover 115.

Advantageously, the cover 115 covers, at least partially, the support 11. For example, the cover 115 covers the intermediate portion 15 and the intermediate portion 15. Advantageously, the cover 115 consists of a protective layer that can be made of any material; preferably, the cover 115 is configured to prevent damages to the track 112 and/or the pin 10.

According to the examples shown in FIGS. 1 to 5, the support 11 of the pin 10 has flat surfaces. According to the examples shown in FIGS. 1 to 5, the support 11 is a single piece laterally delimited by two flat surfaces identified hereinafter as front surface 18 and rear surface 19 respectively. According to a variant not shown, the surfaces 18 and 19 are at least partially curved, in other words, the surfaces 18 and 19 are non-planar.

The front surface 18 and the rear surface 19 are connected to each other by two lateral surfaces identified hereinafter as left surface 20 and right surface 21. Advantageously, the left surface 20 and the right surface 21 are curved. Preferably the left surface 20 and the right surface 21 projected onto the transverse plane πzy are arc portions of a same circumference circumscribed by two angles equal and opposite to each other with respect to the longitudinal plane of symmetry πxz. In other words, the front surface 18 and the rear surface 19 projected onto the transverse plane πzy are two parallel chords, equal and opposite to each other with respect to the lateral plane πxy (FIG. 3).

According to the example shown in FIG. 1 or 2, the foot 16 is configured to be fixed to the shank 2 according to a process selected from a group of processes differing from each other and comprising, for example: screwing; gluing; welding; vibro-welding; brazing; interlocking; interference, riveting; ultrasonic welding; crimping or equivalent methods.

According to the example shown in FIGS. 1 and 2, advantageously, the foot 16 is at least partially covered by a coating 23, which is configured to fix the foot 16 to the shank 2. For exemplary though non-limiting purposes, the coating 23 may be selected from a group of coatings differing from each other depending on the type of fastening to be performed (welding, gluing, or similar) to permanently connect the foot 16 and shank 2 to each other.

The head 14 is configured to be manipulated, i.e. to be picked up and/or moved (manually, by a robotic arm, tool or equivalent means). In particular, advantageously, the head 14 has gripping areas. By way of exemplary and non-limiting purposes only, according to the example shown in the enlargement A of FIG. 2, the head 14 has one or more abutments 14I which are configured to be placed in contact, in use, against the base surface 7 of the housing 6.

According to the example shown in the enlargement A of FIG. 2, the perimeter of the head 14 projected onto the lateral plane πxy is T-shaped. In other words, the head 14 has an end 14I that protrudes along the axis Y′ on both sides of a connecting portion 14II. The connecting portion 14II extends along the longitudinal axis X′ and connects each end 14I with the intermediate portion 15. Thus, the head 14 has two abutments 14I, i.e. the ends of the T-shaped head.

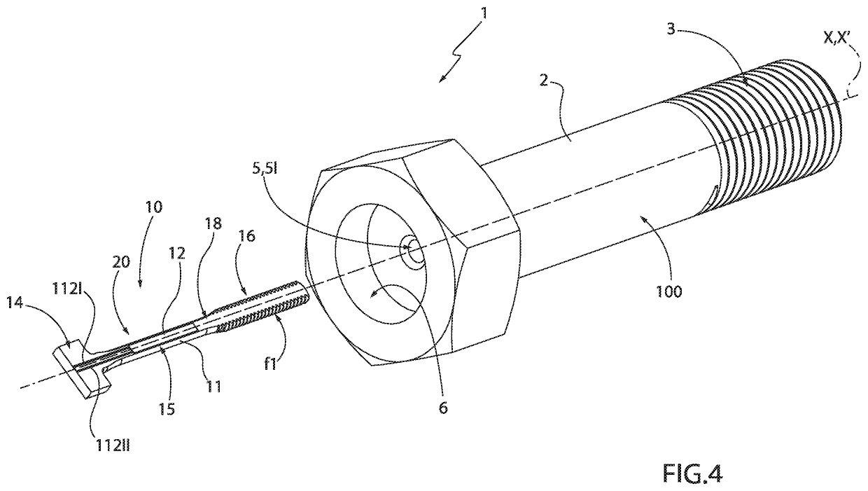

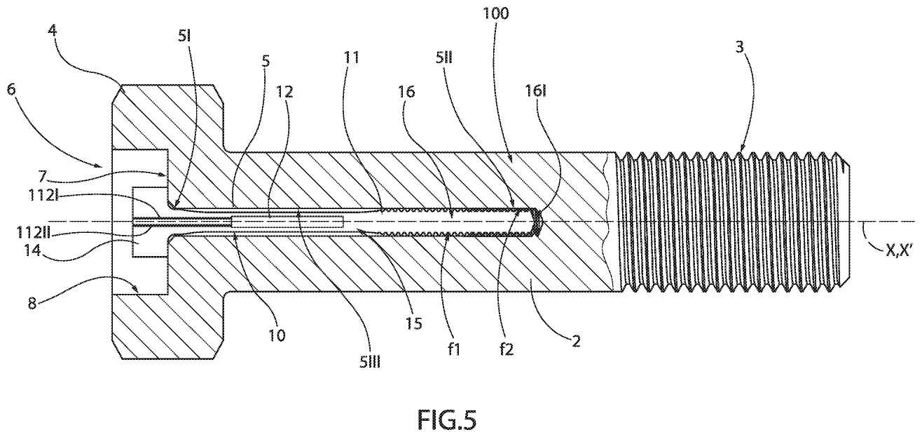

In FIGS. 4 and 5 variants of the sensorized fastener 1 according to the present invention are show. Note that in FIGS. 4 and 5 the components in common with the example previously shown maintain the same numbering and are to be considered as included, without repeating them for the sake of brevity.

According to the variant shown in FIGS. 4 and 5, the foot 16 has a thread f1 and the end portion 5II has a thread f2. The foot 16 and the end portion 5II are screwed to each other.

In particular, only the left surface 20 and the right surface 21 have the thread f1. In this case, the thickness of the foot 16, i.e. the extension along the axis Z′ of the support 11 is a function of the fastening forces to be obtained between the shank 2 and the foot 16. According to variants not shown, the foot 16 and end portion 5II are not only screwed together but are also attached to each other in alternative ways, e.g. the foot 16 is welded or glued to the end portion 5II.

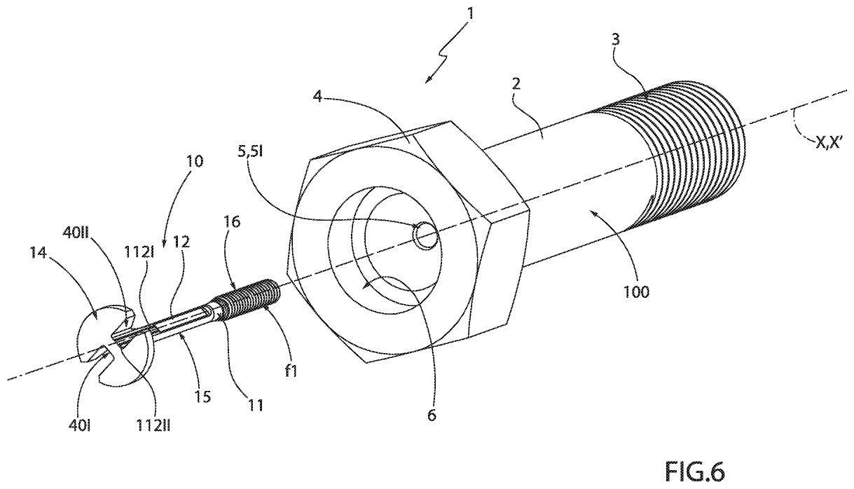

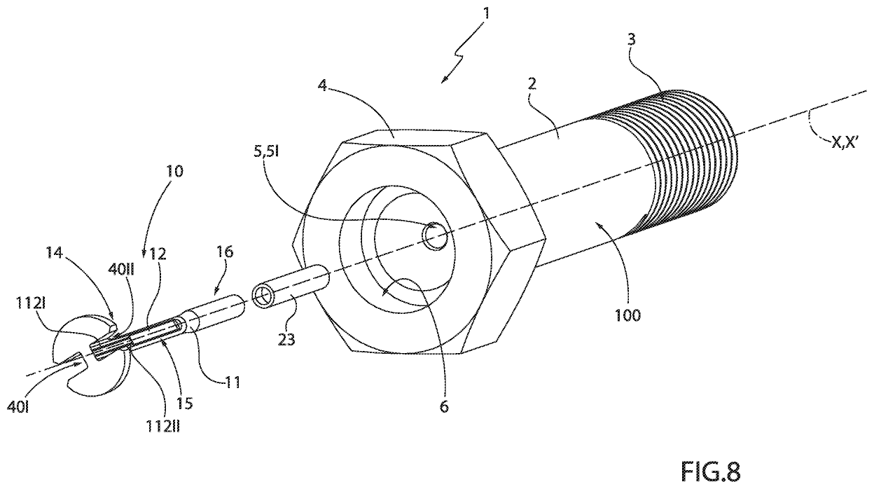

In FIGS. 6 to 9 variants of the sensorized fastener 1 according to the present invention are shown. Note that in FIGS. 6 to 9 the components in common with the example previously shown maintain the same numbering and are to be considered as included, without repeating them for the sake of brevity.

According to the examples shown in FIGS. 6 to 9, the intermediate portion 15 and the foot 16 are axial-symmetrical bodies, in particular cylindrical, with diameters differing from each other.

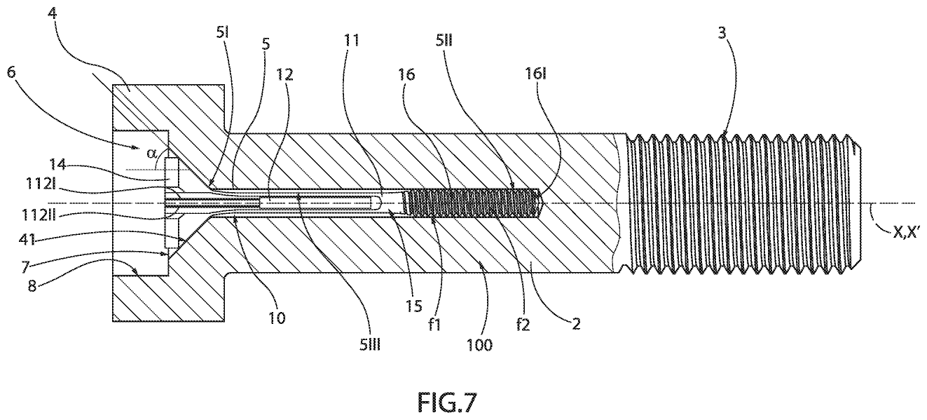

In FIGS. 6 to 9, the head 14 of the pin 10 has a truncated cone shape with an axis of symmetry coaxial to the longitudinal axis X′. The end 14II of the head 14 connected to the intermediate portion 15 has a smaller diameter than the diameter of the end d 14III facing outwards. The taper a of the head 14 is a function of the type of coupling to be realized with the fastening body 100, as will be shown in more detail hereinafter. The head 14 has two equal and opposite grooves 401, 40II extending along the longitudinal axis X′. The dimension and shape of the grooves 401, 40II are configured so that a tool (a gripping element, a manipulator or equivalent element) may grasp the head 14 and move it. Advantageously, the cavity 5 has a tapered portion 41 (FIG. 7) with a taper complementary to that of the pin 10, so as to obtain a tapered coupling between the head 14 and the fastening body 100. Advantageously, the head 14 is fixed to the fastening body 100 according to a process selected from a group of processes differing from each others and comprising, for example: gluing; welding; vibro-welding; brazing; interlocking; interference; riveting; ultrasonic welding; crimping or equivalent methods.

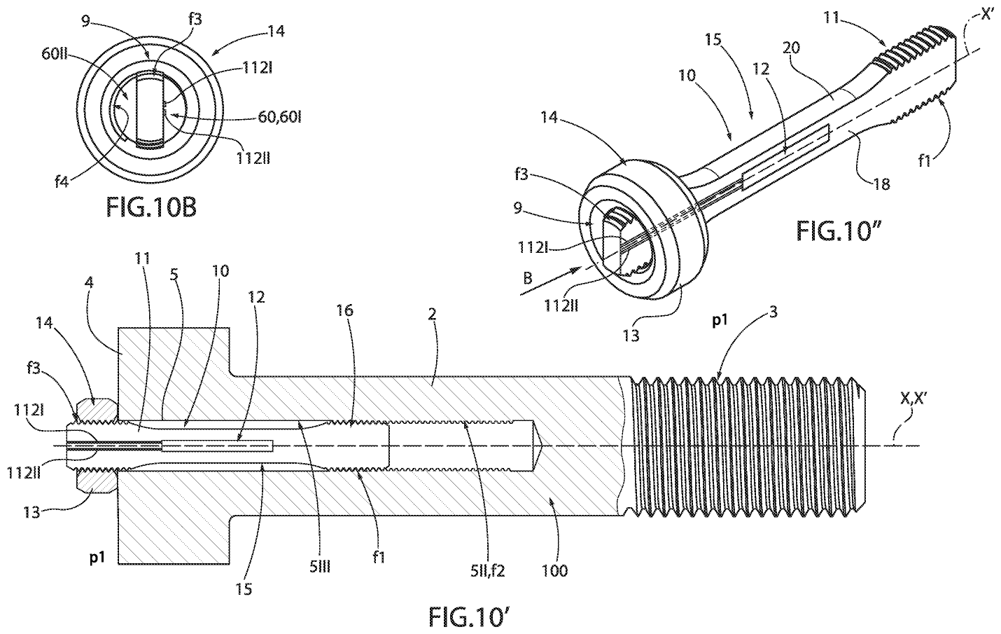

In the variant shown in FIGS. 10′, 10″ and 10B, the components common with the embodiments previously described maintain the same numbering and are considered to be included therein without repeating them for the sake of brevity. Basically, the support 11 is of the type previously described and shown in FIGS. 1 to 5. According to the variant shown in FIGS. 10′, 10″ and 10B, unlike the previous variants, the support 11 has an end portion 9 with an external thread f3. In addition, the pin 10 comprises a nut 13 which is crossed, in a known manner, by a longitudinal hole 60 and has an internal thread f4. The nut 13 is fitted and screwed to the end portion 9.

According to the example shown in FIGS. 10′, 10″ and 10B, the head 14 of the pin 10 is formed by the coupling between the nut 13 (or any equivalent element) and the end portion 9. When the pin 10 is inserted into the cavity 5, the nut 13 is led to abut against a respective portion of the fastening body 100 (according to the example shown against the head 4).

The support 11 has, similarly to what has been described above, a front surface 18 and a rear surface 19 that are substantially flat and connected by a left surface 20 and a right surface 21 that are curved. The thread f3 is made on the curved left surface 20 and the right surface 21.

In particular, two openings are obtained between the nut 13 and the support 11, hereinafter referred to as 60I and 60II, i.e. portions of the hole 60, which longitudinally cross the nut 13. Advantageously, the openings 601 and 60II allow the passage of any bodies, such as: wiring, electrical connecting elements or the like. According to the example shown, the sensing element 12 is applied on the front surface 18 and the two connecting tracks 112I and 112II extend along the support 11 up to the head portion 9 through the opening 60I to allow the connection n of the sensing element 12 with external components. According to a variant not shown, the support 11 has a substantially cylindrical body like the example shown in FIGS. 6 to 9.

In FIGS. 10′, 10″ and 10B, the nut 13 has circular outer lateral perimeter.

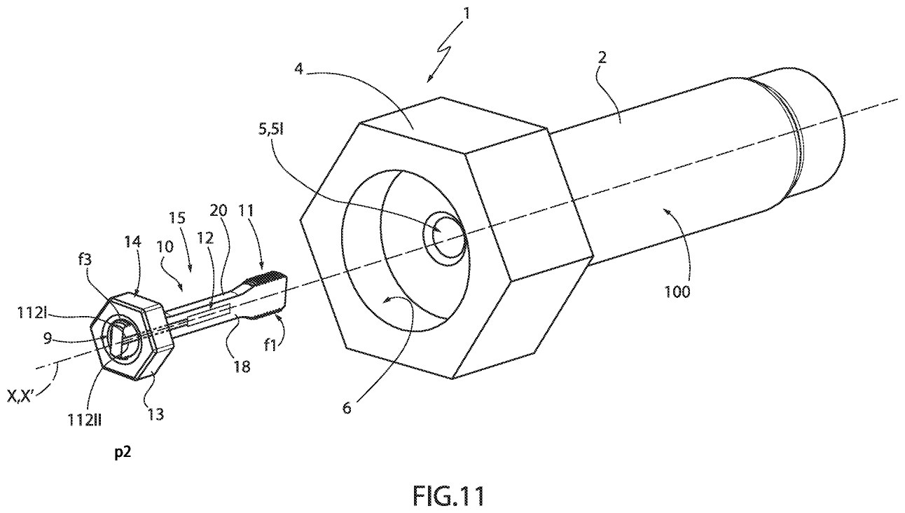

In FIG. 11 a variant of the example shown in FIGS. 10′, 10″ and 10B is shown, the components in common with the previously described embodiments maintain the same numbering and are considered to be included therein without repeating them for the sake of brevity. Basically, the support 11 is of the type previously described and shown in FIGS. 1 to 5. According to the variant shown in FIG. 11, the head 14 of the pin 10 is formed by the coupling between the nut 13 (or any equivalent element) and the head end 9. In particular, the nut 13 has a hexagonal outer lateral perimeter p2. Without losing generality, the outer lateral perimeter of the nut 13 may be of a different closed polygonal shape.

According to a variant not shown, the nut 13 is fixed to the fastening body 100 according to a process selected from a group of processes differing from each other and including, for example: gluing; welding, vibro-welding, brazing, interlocking, interference, riveting, ultrasonic welding, crimping or equivalent methods.

A production process for producing a sensorized fastener 1 according to the present invention is hereinafter described.

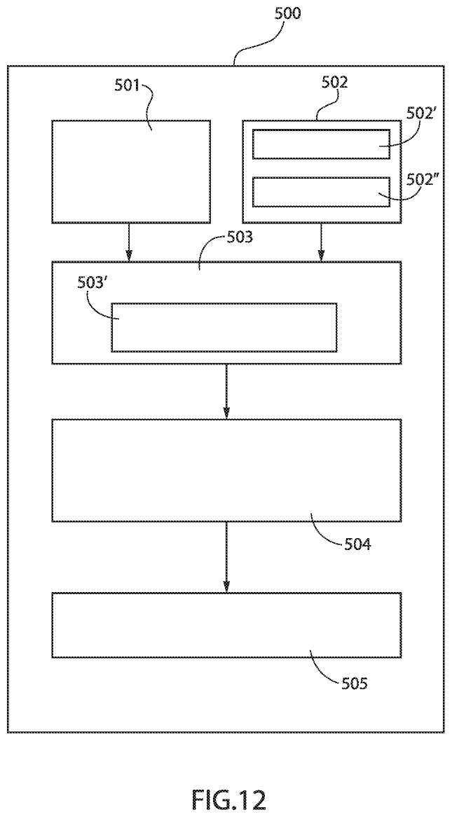

The process according to the present invention may be carried out along a processing line 500 as schematised in FIG. 12. The processing line 500 can operate continuously or in steps. The processing line 500 comprises: a feeding station 501 of fastening bodies 100; and a feeding station 502 of pins 10. Without losing generality, the feeding station 501 of fastening bodies 110 and the feeding station 502 of pins may be part of a single machine unit, i.e. converge in the same area along the processing line 500.

Advantageously though non-exclusively, the feeding station 502 of inserts 10 comprises an application sub-station 502′ for making and/or applying the track 112 on the support 11 of the pin 10. Preferably the application station 502′ provides executing an additive-type material deposition process, also generally known as material deposition. Alternatively, the application station 502′ provides executing an electro-chemical deposition process.

In addition, the processing line 500 comprises: an assembly station 503 for inserting the pin 10 into the fastening body 100; a processing station 504 for fastening the pin 10 inside the fastening body 100 and an output station 505.

Advantageously though non-exclusively, the assembly station 503 comprises an application sub-station 503′ to realize and/or apply the coating 23 on the foot 16 of the pin 10.

Without losing generality, the feeding station 501 of fastening bodies 100, the feeding station 502 of pins and the assembly station 503 may be part of a single machine unit, i.e. they may be realized on board a single machine.

The production process for producing a sensorized fastener 1 according to the present invention is shown hereinafter. Of course, what is described hereinafter can be replicated in parallel or in succession for producing a plurality of sensorized fasteners 1.

The phases hereinafter described are not necessarily performed in the order of presentation used, but may be performed in different sequences and even simultaneously. The steps described hereinafter can also be carried out at distinct and separate machining centres within a single plant or even in different plants. The following production process may be carried out not uniquely along a single processing line 500 in some or all of its phases.

The production process comprises the phase of feeding a fastening body 100 to the feeding station 501. The fastening body 100 fed to the feeding station 501 can come from a stock or a previous processing line.

The production process comprises the phase of feeding a pin 10 to the feeding station 502. The pin 10 fed to the feeding station 502 may either come from the stock or from a previous processing line.

Advantageously though non-exclusively, the phase of feeding a pin 10 comprises the sub-step of applying the sensing element 12 to the support 11 of the pin 10. The sensing element 12 can be realized directly on the support 11 of the pin so as to be anchored to it; or, the sensing element 12 can be fixed by means of intermediate elements (glue or welding or equivalent systems) on the support 11 of the pin 10. The sensing element 12 can be realised by an additive-type material deposition process, also generally known as material deposition. Alternatively, the sensing element 12 can be realised by an electro-chemical deposition process.

The production process comprises the phase of assembling in correspondence of the assembly station 503. During the phase of assembling, the pin 10 is automatically inserted into the cavity 5 of the respective fastening body 100. Advantageously, the step of assembling comprises the sub-steps of: automatically grasping the head 14 of the fastening body 100 aligning the longitudinal axis X′ of the pin 10 with the longitudinal axis X of the cavity 5 by orienting the foot 16 towards the end portion 5II of the cavity 5; inserting the pin 10 within the cavity 5 so as to dispose the foot 16 in correspondence of the end portion 5II. In case the foot 16 and the end portion 5II are threaded, the sub-step of roto-translating the pin 10 may be provided so that the foot 16 and the end portion 5II are screwed to each other.

Advantageously, though non-exclusively, the phase of assembling may comprise the sub-step of coating, at least partially, the foot 16 with a coating 23 that is configured to fix under certain conditions (depending on temperature, time and pressure), e.g. by gluing or welding, the foot 16 to the end portion 5II.

In case the pin 10 is of the type shown in FIGS. 10′, 10″, 10B and 11, the phase of assembling may comprise the sub-step of forming the head 14 by coupling, in particular screwing, the nut 13 to the head end 9 of the support 11. Advantageously, during the sub-step of forming the head 14, a determined preload can be applied to the support 11 depending on the degree to which the nut 13 is screwed onto the thread f3 of the head end 9.

The production process comprises the phase of fixing the pin 10 to the fastening body 100. The phase of fixing may also be carried out at the assembly station 503. The phase of fixing may comprise the sub-step of adjusting the fastening torque between the foot 16 and the end portion 5II so as to ensure a stable and long-lasting coupling between the pin 10 and the fastening body 100. In particular, the tightening torque is determined according to the type of coupling desired between the foot 16 and the end portion 5II.

The phase of fixing may comprise the sub-step of activating any coating 23 so as to permanently fix (e.g. glue or weld) the foot 16 to the fastening body 100. Advantageously, the phase of fixing comprises the sub-step of fixing the head 14 to the fastening body 100, e.g. by gluing and/or welding.

Advantageously, the phase of fixing may comprise the sub-step of heating. The sub-step of heating may be selected from a group of different heating methods, such as: by and induction oven, induction, microwave, or equivalent systems.

The production process further comprises the phase of feeding the sensorized fasteners 1 directly to a packaging unit for stocking and distribution.

The production process may comprise one or more quality control phases or sub-steps (of the known type and not shown) to reject any defective pieces.

A pin 10 of the type described above has the advantage that it has a rigid support 11 which can also be automatically manipulated and that can be inserted and automatically fixed inside the cavity 5 of a fastening body 100. In other words, the pin 10 is a thin body that can be manipulated in an automated manner. The pin 10 allows the assembly of a sensorized fastener 1 to be automated.

Advantageously, the pin 10 of the type shown in FIGS. 10′, 10″, 10B and 11 may be quickly and easily assembled.

In case the pin 10 is made of the same material (or of an equally comparable material in terms of electro-chemical and mechanical properties) as the fastening body 100, a uniformity between the physical phenomena developing between the support 11 of the pin and the fastening body obtained, thereby improving the 100 is advantageously reliability of the signals detected by the sensing element 12. In case the pin 10 is made of a more yielding material, i.e. having a lower Young modulus than the material of the fastening body 100, it is advantageously possible to amplify the effect of the tensile stress on the pin 10 in a determined manner and to ease detecting and reading the corresponding signals.

The pin 10 according to the present invention integrally supports the sensing element 12, thereby drastically reducing the likelihood of the sensing element 12 detaching, during use, from the pin 10 itself.

The pin 10 withstands high temperatures and stress.

The production process and processing line 500 according to the present invention allow to drastically reduce the production costs of the sensorized fasteners 1, thereby facilitating the widespread use of sensorized fasteners 1 even under normal working conditions of mechanical apparatuses (i.e. not under test conditions). This results in clear advantages in terms of active and predictive control of mechanical apparatuses.

1. A sensorized fastener, comprising a fastening body having a first longitudinal axis and a cavity, which is laterally delimited by a lateral surface and extends along said first longitudinal axis between an opening, through which the cavity faces outside from the fastening body itself, and an end portion; wherein the sensorized fastener comprises a pin, which comprises, in turn, a support and a sensing element; wherein said support has a second longitudinal axis and comprises a head, a foot and an intermediate portion, which is interposed along said second longitudinal axis between the head and the foot; said sensing element being disposed in correspondence of said intermediate portion; said pin is inserted, at least partially, through said opening into the cavity of the fastening body (100) so as to dispose the foot of the pin in correspondence of the end portion of the cavity; wherein said intermediate portion and the respective sensing element are housed, at least partially, in the cavity; wherein said foot is fixed to said end portion of the cavity.

2. The sensorized fastener according to claim 1, wherein said foot (16) and said end portion are threaded and screwed together; in addition or alternatively, the foot of the pin is welded, or glued, to the end portion of the cavity.

3. The sensorized fastener according to claim 1, wherein the sensing element is housed, at least partially, in the cavity without contact with the lateral surface of the cavity itself.

4. The sensorized fastener according to claim 1, wherein the head of the pin protrudes, at least partially, outside from the opening of the cavity; wherein said head has one or more abutments configured to be placed in contact against respective portions of said fastening body.

5. The sensorized fastener according to claim 1, wherein said support has a head portion, which has, in turn, an external thread; wherein, said support comprises a nut (13) crossed by a longitudinal hole (60) and having an internal thread; the nut is configured to be screwed to said external thread of the head portion; wherein, the head of the support is generated by the coupling between said nut and the head portion.

6. The sensorized fastener according to claim 1, wherein said pin is made of the same material of said fastening body or said pin has chemical and/or physical and/or mechanical properties equal to the ones of the fastening body.

7. A pin for a sensorized fastener according to claim 1 and comprising a support and a sensing element; wherein said support has a second longitudinal axis and comprises a head, a foot and an intermediate portion, which is interposed along said second longitudinal axis between the head and the foot; wherein said sensing element is disposed in correspondence of said intermediate portion; wherein the sensing element has been made by means of an additive process or by means of a chemical process of electrodeposition.

8. The pin according to claim 7, wherein said support has a head portion, which has, in turn, an external thread; wherein said support comprises a nut crossed by a longitudinal hole and having an internal thread configured to be screwed on said external thread of the head portion; wherein the head of the support is generated by the coupling of said nut and the head portion.

9. A process for the production of a sensorized fastener, and comprising the phases of:
providing a fastening body; said fastening body having a first longitudinal axis and a cavity which extends along said first longitudinal axis between an opening, through which said cavity faces outside from the fastening body, and an end portion; said cavity being delimited laterally by a lateral surface;
providing a pin which comprises a support and a sensing element; said support having a second longitudinal axis and comprising, in turn, a head, a foot and an intermediate portion; wherein the intermediate portion is interposed along said second longitudinal axis between the head and the foot; said sensing element being disposed in correspondence of said intermediate portion;
inserting said pin into the cavity of the fastening body so as to dispose said foot in correspondence of the end portion and dispose, at least partially, the intermediate portion of the pin into the cavity; in particular, the sensing element not being in contact with the lateral surface of the cavity; and
fixing the foot of the pin to the end portion of the cavity.

10. The process according to claim 9, wherein the phase of providing pin comprises the sub-step of realizing, or gluing, a sensing element in correspondence of said intermediate portion; wherein the sub-step of realizing comprises to execute an additive process or to execute an electro-chemical deposition process.

11. The process according to claim 9, wherein the phase of providing a pin comprises the sub-step of covering, at least partially, the foot with a coating, which is configured to fix the foot to the end portion.

12. The process according to claim 11, wherein the phase of fixing comprises the sub-step of screwing the foot of the pin to the end portion of the cavity; wherein the phase of fixing comprises the sub-step of screwing the foot and the nut of the head; wherein during the sub-step of screwing, the tightening torque is function of the preload to be applied to the intermediate portion of the pin.

13. The process according to claim 9, wherein the phase of inserting comprises to dispose the head of the pin outside from said cavity; wherein the phase of inserting comprises the sub-step of fixing the head of the pin to the fastening body; wherein the phase of inserting comprises the sub-step of gluing or welding the head of the pin to the fastening body.

14. A processing line for the production of a sensorized fastener comprising an insert and configured to implement a process according to claim 8; said processing line comprising:
a first feeding station of a fastening body, namely a cylindrical body, having a first longitudinal axis and a cavity, which extends along said first longitudinal axis between an opening, through which said cavity faces outside from the fastening body, and an end portion; said cavity being delimited laterally by a lateral surface;
a second feeding station of a pin which comprises a support and a sensing element; wherein said support has a second longitudinal axis and comprises, in turn, a head, a foot and an intermediate portion; wherein the intermediate portion is interposed along said second longitudinal axis between the head and the foot and said sensing element is disposed in correspondence of said intermediate portion;
an assembly station wherein said pin is inserted into said cavity so as to dispose said foot in correspondence of the end portion and house, at least partially, the intermediate portion of the pin into the cavity.

15. The processing line according to claim 14, wherein in correspondence of the assembly station is realized the fixing of the foot of the pin to the end portion of the cavity (5).

16. The processing line according to claim 15 and comprising a fixing station wherein the foot of the pin is fixed to the end portion of the cavity.
